(19) United States
(12) Patent Application Publication
(10) Pub. No.: US 2014/0321152 A1
(43) Pub. Date: Oct. 30, 2014

(54) LIGHT UP CENTERPIECE

(71) Applicant: Paul E. Cayton, New York, NY (US)

(72) Inventor: Paul E. Cayton, New York, NY (US)

(21) Appl. No.: 13/869,114

(22) Filed: Apr. 24, 2013

(51) Int. Cl. F21V 33/00; F21V 8/00

(52) U.S. Cl. CPC F21V 33/0028; G02B 6/0005
USPC 362/555

(57) ABSTRACT

A light up centerpiece including a plurality of optical fibers, a plurality of non-light up strands and other decorative elements, a molded opening, a plurality of light emitting diodes, a base portion, and a power source. The optical fibers each have first and second ends. The light emitting diodes illuminate the optical fibers, so that the light emitted at the second end of the optical fibers creates an aesthetically decorative light effect. The fibers, strands and decorative elements are proportionately arranged and held in place through an opening in a molded base so that the light is distributed throughout the centerpiece.

### BACKGROUND OF THE INVENTION

Table top centerpieces are aesthetically pleasing and commonly used to adorn tables at festive occasions, such as engagements, weddings, confirmations and birthday parties. A centerpiece will commonly take the form of a vase or bowl containing a bouquet of cut flowers. Sometimes, candles are also included in the centerpiece. Since flowers inevitably wilt, centerpieces may be devised of durable plastic and other materials. An advantage of such an approach is that it allows further decorative effect to be achieved by lighting of the centerpiece. However, lighting of a centerpiece is often uneven, and can detract from the decorative effect. Accordingly, there exists a need for durable, reuseable centerpieces, which achieve a satisfying decorative effect by arranging a mixture of light-up elements with non-light up decorative strands and other decorative elements so that the light is evenly distributed throughout the centerpiece and not just in one specific area.

U.S. Pat. No. 5,683,762 discloses a centerpiece assembly simulating a floral arrangement. The floral arrangement is achieved by decorating hollow flower stems with decorative pom-pom-like “flowers.”

U.S. Pat. No. 7,073,092 discloses a decorative assembly for use within a floral arrangement that includes a plurality of optical fibers, a plurality of light emitting diodes, a base portion, and a power source. The optical fibers each have first and second ends. The light emitting diodes are coupled to the first end of each of the optical fibers for illuminating the optical fibers. The base portion houses the power source, the lighting emitting diodes and at least a portion of the optical fibers. The optical fibers are illuminated such that the light emitted at the second end of the optical fibers creates an aesthetically decorative effect within the floral arrangement.

### SUMMARY OF THE INVENTION

It is the primary object of the invention to provide an inexpensive light up centerpiece, said centerpiece comprising: (a) a plurality of optical fibers, each having a first end and a second end; (b) a plurality of non-light up strands mixed with the optical fibers; (c) decorative elements attached to or separate from the non-light up strands; (d) a molded piece into which one end of the optical fibers and non-light up strands are fit; (e) light emitting diodes arranged so as to illuminate said first ends of said optical fibers; (f) a base portion for housing said lighting emitting diodes and retaining said molded piece into which said optical fibers and non-light up strands are fit; (g) a power source coupled to said light emitting diode; (h) the plurality of optical fibers being illuminated such that the light emitted at the second end of said optical fibers creates an aesthetically decorative light effect; and (i) where said optical fibers are proportionately arranged in said molded opening so that the light is distributed throughout the centerpiece and not just to one specific area.

Another preferred embodiment of the invention includes a light up centerpiece, said centerpiece comprising: (a) a plurality of optical fibers, each having a first end and a second end; (b) a plurality of non-light up strands mixed with the optical fibers; (c) decorative elements attached to a separate set of non-light up strands; (d) a molded opening into which the optical fibers and non-light up strands are fit; (e) a plurality of light emitting diodes arranged so as to illuminate said first ends of said optical fibers; (f) a base portion for housing said lighting emitting diodes and said molded opening into which said optical fibers and non-light up strands are fit; (g) a power source coupled to said light emitting diodes; (h) the plurality of optical fibers being illuminated such that the light emitted at the second end of said optical fibers creates an aesthetically decorative light effect; and (i) where said optical fibers are proportionately arranged in said molded opening so that the light is distributed throughout the centerpiece.

Further aspects and advantages of the invention will appear from the following description taken together with the accompanying drawings.

### BRIEF DESCRIPTION OF THE DRAWINGS

The above and other objects and advantages of the invention will be apparent upon consideration of the following detailed description, taken in conjunction with the accompanying figure, in which like reference characters refer to like parts throughout, and in which:

FIG. 1 is a side view of the centerpiece, according to one preferred embodiment of the present invention.

FIG. 2 is an exploded view of the centerpiece, showing the different elements that form it, according to one preferred embodiment of the present invention.

FIG. 3 is a side view of the non-light up strands of the centerpiece, according to one preferred embodiment of the present invention.

FIG. 4 is a side view of decorative shapes and non-light up strands of the light up centerpiece, according to one preferred embodiment of the present invention.

### DETAILED DESCRIPTION OF THE EXEMPLARY EMBODIMENTS

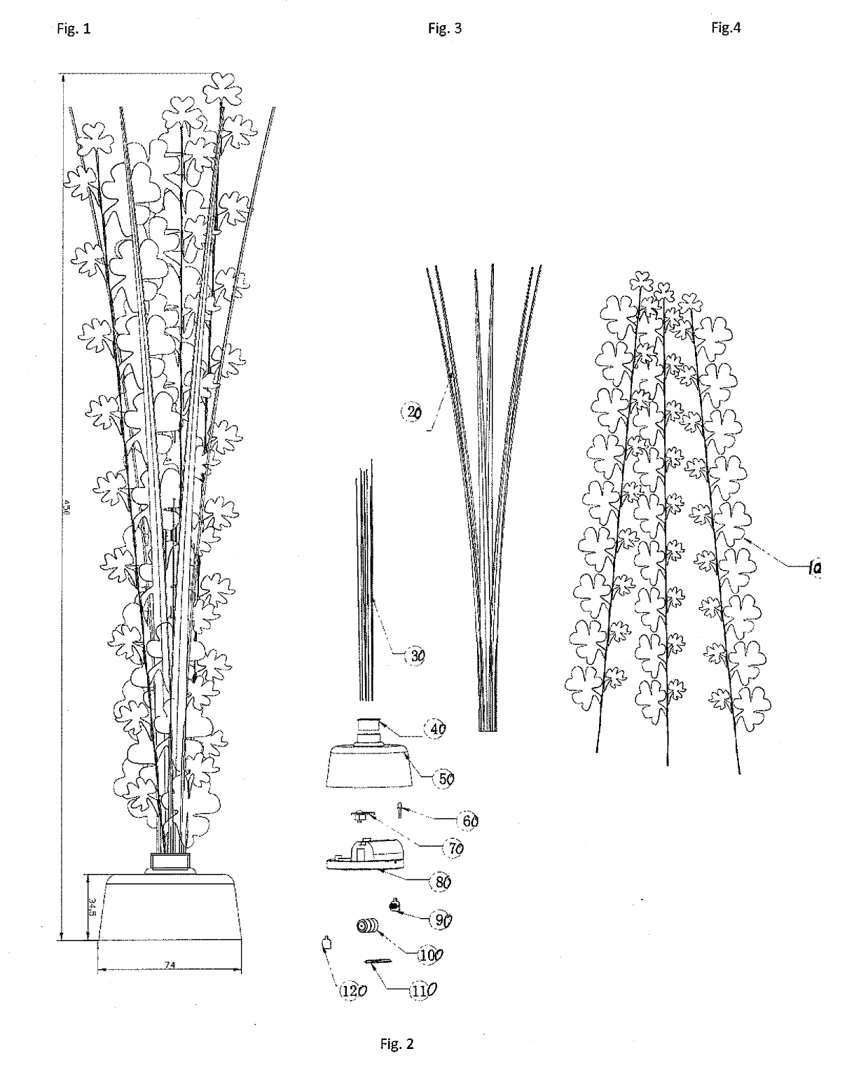

One mode for carrying out the invention is presented in terms of its preferred embodiment, herein depicted within FIG. 1. However, the invention is not limited to the described embodiment and a person skilled in the art will appreciate that many other embodiments of the invention are possible without deviating from the basic concept of the invention, and that any such work around will also fall under scope of this invention. It is envisioned that other styles and configurations of the present invention can be easily incorporated into the teachings of the present invention, and only one particular configuration shall be shown and described for purposes of clarity and disclosure and not by way of limitation of scope.

Headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). The terms “a” and “an” herein do not denote a limitation of quantity, but rather denote the presence of at least one of the referenced items.

Referring now to FIGS. 1-4, a light up centerpiece is disclosed, according to the preferred embodiment of the present invention. As seen in FIG. 3 and FIG. 4, reflective sheet is fashioned into floral shapes (10) or grass-like shapes (20) or any other decorative shapes, such as snowmen, space aliens, cartoon characters, film characters, ghosts, pumpkins, etc. The decorations may be made of tin foil or aluminum or colored plastics or other visually eye-catching materials. Decorations may be attached to the decorative grass-like shapes, the light-up fiber elements or to individual flexible wires that can be inserted into the centerpiece for this purpose. Such flexible wires may be twisted and turned to enhance the decorative appearance of the display. Decorations themselves may be made of visually attractive colors, such as reflective silver, and may be either made of disposable materials, or more durable materials. Decorations are attached mechanically, or with adhesive products known to one of ordinary skill in the art. Decorations may also be attached through detachable clips, magnets or other means if desired.

A wide variety of decorative shapes may be used, and may be selected according to the type of event, the location, the season. The decorative shapes may be of a mixture of colors, or varying color, of reflective material, and include licensed media characters, etc. Shapes are strategically arranged by the person assembling the device, for sale to a customer or installation at a venue. The pattern of the shapes may be altered by the twisting or bending the wires on which the shapes are supported. The centerpiece may be used for all kinds of events, such as birthday parties, baby showers, graduation dinners, seasonal parties, etc. Centerpieces can be customized for any type of event.

As seen in FIG. 2, the decorative elements are combined with optical fibers (30) and non-light up decorative strands, aligned and inserted into a ring (40) which fits into a housing (50). Both the ring and housing are preferably fashioned from plastic materials, such as ABS. The housing includes an LED lighting assembly (60) positioned so as to illuminate the optical fibers, such that the optical fibers are illuminated. Preferably, the top half inch of the ends of the optical fibers illuminate with light.

The LED lighting assembly is controlled by a printed circuit board (“PCB”) (70). The LED lighting assembly may also be controlled by more advanced electronic components, such as an ASIC or programmable computer. The base (80) also contains a power unit, which is preferably fashioned in the bottom wall of the base. The power unit includes a positive plate (90) typically made of Mn-steel. The power unit contains one or more batteries, such as a zn-mn battery (100), a battery cover (110), and a negative plate (120) made of Mn-steel. None of the materials involved are considered limiting of the invention. In the alternative, the battery could be a rechargeable battery, or the centerpiece base could be wired for AC power.

Optical fibers are conventional plastic optical fiber and can be of various thicknesses (e.g. having a diameter of 20 mm, 30 mm, and/or 40 mm) or lengths. Fibers may be made of any other materials suitable for transmission of light known to one of ordinary skill in the art. It should be understood that any number of individual optical fibers could be utilized, depending on the desired size of the centerpiece. The mixture of optical fibers to non-light up elements may also be selected. For example, the optical fibers may be in approximately a 50:50 ratio with non-light up strands, or a 40:60 ratio, or a 30:70 ratio. It has been found that a mixture of optical fibers to non-light up strands in the range of from about 50:50 to about 30:70 produces an aesthetically pleasing centerpiece. The optical fibers are generally shorter than the decorative strands and wires supporting decorations. The optical fibers can be held in alignment with the LEDs housed in the base by means of the ring (a molded opening). Specifically, one or more optic fibers may be glued into the ring using standard adhesive products known to one of ordinary skill in the art.

To assemble the device, the optical fibers are strategically positioned with the other non light up strands/wires and all funnel into the molded opening. The base of the optical fibers is above the LEDs in the housing. The light then lights up towards the opening to light up all the fiber optics. Optical fibers are proportionately arranged in the opening so the light is distributed throughout the centerpiece and not to just one specific area.

The optical fibers are oriented within the molded opening such that the end face of each optic fiber within the housing is positioned relatively orthogonal to the top surface of the LED that is secured within the housing. The distance between the end of the fiber and the top of the LEDs is preferably as short as possible. The molding opening is made so there is a very tight fit to the optical fibers and other decoratives, so that the fibers and other decoratives are held securely in place and cannot be removed without difficulty.

Before placing into the molded opening, the lower end of the collected strands, fibers and decorative wires may be bound together using adhesive tape or a rubber band, wrapped tightly around the bases, so as to bind them together in a tight collective bunch. In the alternative, a molded plastic collar with a flexible neck opening which closes to seal the strands within the collar can be used. Once inserted into the opening of the base, the tape, band or collar holds the elements securely to the base. After insertion into the base, the optical fibers and other parts spread out in an attractive pattern. The optical fibers are proportionately arranged in the opening (the ring) so the light is distributed throughout the centerpiece and not just to one specific area. All the fiber optic strands and the non-light up strands should be positioned uniformly at the bottom, so they are aligned in the base, so the light will light up all the fiber optic strands evenly. The entire centerpiece lends itself to allow the user to rearrange the visible fibers and strands, and decoratives, which are made of any suitable flexible wire material so as to be easily adjustable.

Optical fibers can be of the same length or can be of variable length according to the preference of the customer or designer. That is, optical fibers can be cut at various lengths and this can occur either at the time of manufacture or during assembly (e.g. by a purchaser or user). Variable length of the optical fibers enables variable light positions to be obtained, such that light is uniform throughout the centerpiece. In the alternatives, the centerpiece can be constructed so that light appears at two or three specific points, such as rings, around the device.

Also, it should be understood that the centerpiece can be adapted for use with other arrangements than the arrangement illustrated in FIG. 1. The entire centerpiece lends itself to allow the user to rearrange the visible fibers and decorative strands, which are made of a flexible material which is easily adjustable.

As conventionally known, LEDs are semiconductor devices that emit a visible light when current biased in the forward direction. Unlike standard bulb type lamps, LEDs are immune to failure conditions such as filament breakage due to sudden shocks or bumps and are well suited for use in articles that may experience sudden impacts from being bounced or shaken. In addition, LEDs are highly energy efficient as they only require a small amount of electricity to generate a relatively strong light. For example, a typical incandescent lamp operates on 5 volts and uses a current of 115 milliamps while a LED can operate on 3 volts and draw current on the order of 15 milliamps.

LEDs are a particularly desirable lighting source in applications involving small and lightweight devices where the desired size and weight limits the strength of power sources available, thereby making energy efficiency important. Since the rated lifetime of these LEDs is approximately 15 years, the LED assembly provides the centerpiece with an extremely energy efficient, long lasting (i.e. so that the centerpiece can be re-useable), light weight and durable light source. Optionally, three LED light bulbs are used, in the colors of red, green and blue.

The lights may be controlled by a controller that allows the lights to be set for one specific color or programmed to change through multiple colors. The slow color changing of the LEDs is known as “modesmorphing” as understood by one of ordinary skill in the art. The lights have an integrated circuit on the PCB that allows the lights to change through the colors. The device can include a switch or a button, for example, on the bottom of the centerpiece that allows the user to choose from different light modes, such as all green, all red, all blue, all purple, all orange, all majenta, all rainbow of colors or a mode where the lights will automatically change through the other available modes in a slow pattern. The button controlling the integrated circuit is preferably a push button which can cycle through each mode with each push, including a final “off” mode to switch off the lights.

Alternatively, the device can be designed with only a single mode, and can include only an on-off button. The modes of light pattern and means of switching between them are not limiting on the invention. The base is preferably three inches in diameter, and round, but height and weight may vary according to the preference of the customer or designer. The base can be motorized if desired.

Power source is preferably two or three conventional penlight “AAA” cell batteries secured by battery holder tabs and positioned in series. By placing the batteries in series, it is possible to increase the brightness of LED assembly since typically this product would not need to be used for more than a few hours at a time. However, it should be understood that the batteries could also be positioned in parallel to provide for longer life. Also, it should be understood that base portion could be adapted to allow batteries to be replaced. The base may also have a plastic lid covering the battery compartment, secured by screws. The base itself may be made of translucent material which shows the colors of the LEDs when lit, thus creating a more attractive display by lighting the base as well as the fibers.

The light driver circuit is a conventional LED driving circuit that selectively activates the LED. The light driver circuit is implemented as a conventional PCB circuit board and is positioned between power source and LED such that the LED leads can be inserted directly into the PCB board. The light driver circuit can also be adapted to provide gradually changing (i.e. increasing and/or decreasing) levels of power to the LEDs to create “fade” lighting effects. Finally, the speed at which random, sequential or gradually changing levels of power are provided to the LEDs can be adjusted depending on the type of effect desired. It should be understood that if “blinking” LEDs are utilized within LED assembly then it would not be necessary to use a light driver circuit within the centerpiece. The kinds of LEDs used are not limitation upon the invention.

The foregoing descriptions of specific embodiments of the present invention have been presented for purposes of illustration and description. They are not intended to be exhaustive or to limit the invention and method of use to the precise forms disclosed. Obviously many modifications and variations are possible in light of the above teaching. It is understood that various omissions or substitutions of equivalents are contemplated as circumstance may suggest or render expedient, but is intended to cover the application or implementation without departing from the spirit or scope of the claims of the present invention.

What is claimed is:

1. A light up centerpiece, said centerpiece comprising: (a) a plurality of optical fibers, each having a first end and a second end; (b) a plurality of non-light up strands mixed with the optical fibers; (c) decorative elements attached to the non-light up strands; (d) a molded opening into which the optical fibers and non-light up strands are fit; (e) a plurality of light emitting diodes arranged so as to illuminate said first ends of said optical fibers; (f) a base portion for housing said lighting emitting diodes and said molded opening into which said optical fibers and non-light up strands are fit; (g) a power source coupled to said light emitting diodes; (h) the plurality of optical fibers being illuminated such that the light emitted at the second end of said optical fibers creates an aesthetically decorative light effect; and (i) where said optical fibers are proportionately arranged in said molded opening so that the light is distributed throughout the centerpiece.

2. The centerpiece of claim 1, wherein the optical fibers have the same length.

3. The centerpiece of claim 1, wherein the optical fibers are of two different lengths.

4. The centerpiece of claim 1, wherein the optical fibers have the same diameter.

5. The centerpiece of claim 1, wherein the optical fibers are of two different diameters.

6. The centerpiece of claim 1, wherein an outer surface of at least one of the plurality of the optical fibers is covered with a coating adapted to ensure that light is primarily emitted from the second end of the at least one of the plurality of the optical fibers.

7. The centerpiece of claim 6, wherein at least a portion of the coating on the outer surface of at least one of the plurality of the optical fibers is removed to form an opening, such that light is allowed to escape through the opening.

8. The centerpiece of claim 1, wherein said plurality of light emitting diodes emits the same color.

9. The centerpiece of claim 1, wherein each of said plurality of light emitting diodes emits a different color.

10. The centerpiece of claim 1, wherein said light emitting diodes emit a plurality of different colors.

11. The centerpiece of claim 1, wherein said light driver circuit is adapted to activate said plurality of light emitting diodes by applying gradually changing levels of power from said power source such that a gradual fade effect is created.

12. A light up centerpiece, said centerpiece comprising: (a) a plurality of optical fibers, each having a first end and a second end; (b) a plurality of non-light up strands mixed with the optical fibers; (c) decorative elements attached to a separate set of non-light up strands; (d) a molded opening into which the optical fibers and non-light up strands are fit; (e) a plurality of light emitting diodes arranged so as to illuminate said first ends of said optical fibers; (f) a base portion for housing said lighting emitting diodes and said molded opening into which said optical fibers and non-light up strands are fit; (g) a power source coupled to said light emitting diodes; (h) the plurality of optical fibers being illuminated such that the light emitted at the second end of said optical fibers creates an aesthetically decorative light effect; and (i) where said optical fibers are proportionately arranged in said molded opening so that the light is distributed throughout the centerpiece.
